(19) United States
(12) Patent Application Publication
(10) Pub. No.: US 2022/0076677 A1
(43) Pub. Date: Mar. 10, 2022

(54) VOICE INTERACTION METHOD, DEVICE, AND STORAGE MEDIUM

(71) Applicant: Beijing Baidu Netcom Science Technology Co., Ltd., Beijing (CN)

(72) Inventors: Yufeng LI, Beijing (CN); Wensi SU, Beijing (CN); Jiayun XI, Beijing (CN); Bufang ZHANG, Beijing (CN); Zixuan ZHOU, Beijing (CN)

(73) Assignee: Beijing Baidu Netcom Science Technology Co., Ltd., Beijing (CN)

(21) Appl. No.: 17/527,445

(22) Filed: Nov. 16, 2021

(30) Foreign Application Priority Data
Mar. 9, 2021 (CN) 202110258490.5

(51) Int. Cl. G10L 15/22

(52) U.S. Cl. CPC G10L 15/22; G10L 2015/225

(57) ABSTRACT

Provided are a voice interaction method, a device and a storage medium, relating to the technical field of data processing and in particular to artificial intelligence technologies such as Internet of Things and voice technologies. The scheme is as follows: in response to a trigger operation of a target user on a voice interaction device, outputting response information; determining, according to a response operation of the target user on the response information, whether a feedback condition is met; and in response to meeting the feedback condition, feeding back emotion guidance information.

### CROSS-REFERENCE TO RELATED APPLICATIONS

This application claims priority to Chinese patent application No. 202110258490.5 filed with the China National Intellectual Property Administration (CNIPA) on Mar. 09, 2021, the disclosure of which is incorporated herein by reference in its entirety.

### TECHNICAL FIELD

The present application relates to the technical field of data processing, in particular, artificial intelligence technologies such as the Internet of Things and voice technologies.

### BACKGROUND

With the continuous development of science and technology, it is gradually popular to solve voice interaction issues such as spoken language training or navigation guidance by using man-machine dialogues achieved through artificial intelligence (AI) technologies.

However, in man-machine dialogue scenarios of the related art, there are usually situations where users have a low interest in AI products and a low stickiness of products due to emotions of the users, seriously affecting the number of stable users of the AI products.

### SUMMARY

The present application provides a voice interaction method and apparatus, a device and a storage medium.

According to the present application, a video interaction method is provided. The method includes steps described below.

In response to a trigger operation of a target user on a voice interaction device, response information is output.

It is determined whether a feedback condition is met according to a response operation of the target user on the response information.

In response to the feedback condition being met, emotion guidance information is fed back.

According to the present application, an electronic device is further provided. The electronic device includes at least one processor and a memory.

The memory is communicatively connected to the at least one processor.

The memory stores instructions executable by the at least one processor, and the instructions are executed by the at least one processor to cause the at least one processor to execute the voice interaction method according to any embodiment of the present application.

According to the present application, a non-transitory computer-readable storage medium is further provided. The non-transitory computer-readable storage medium stores computer instructions for causing a computer to execute the voice interaction method according to any embodiment of the present application.

It is to be understood that the content described in this part is neither intended to identify key or important features of the embodiments of the present application nor intended to limit the scope of the present application. Other features of the present application are apparent from the description provided hereinafter.

### BRIEF DESCRIPTION OF DRAWINGS

The drawings are intended to provide a better understanding of the present scheme and not to limit the present application. In the drawings:

FIG. 1 is a flowchart of a voice interaction method according to an embodiment of the present application;

FIG. 2A is a flowchart of another voice interaction method according to an embodiment of the present application;

FIG. 2B is a schematic diagram of a voice interaction interface according to an embodiment of the present application;

FIG. 2C is a schematic diagram of another voice interaction interface according to an embodiment of the present application;

FIG. 2D is a schematic diagram of another voice interaction interface according to an embodiment of the present application;

FIG. 3 is a flowchart of another voice interaction method according to an embodiment of the present application;

FIG. 4 is a structure diagram of a voice interaction apparatus according to an embodiment of the present application; and

FIG. 5 is a block diagram of an electronic device for implementing a voice interaction method according to an embodiment of the present application.

### DETAILED DESCRIPTION

Example embodiments of the present application, including details of the embodiments of the present application, are described hereinafter in conjunction with the drawings to facilitate understanding. The example embodiments are illustrative only. Therefore, it is to be understood by those of ordinary skill in the art that various changes and modifications may be made to the embodiments described herein without departing from the scope and spirit of the present application. Similarly, for clarity and conciseness, the description of well-known functions and structures is omitted in the description below.

Each voice interaction method and voice interaction apparatus provided in the present application are suitable for the scenario in which voice interaction with users is performed through voice interaction devices in the technical field of artificial intelligence. Each voice interaction method provided in the present application may be executed by a voice interaction apparatus. The apparatus may be implemented by software and/or hardware and is configured in an electronic device. The electronic device may be a terminal device such as a smart speaker, a vehicle-mounted terminal or a smartphone or may be a server device such as a server.

For ease of understanding, the related content of the voice interaction method is first described below in detail.

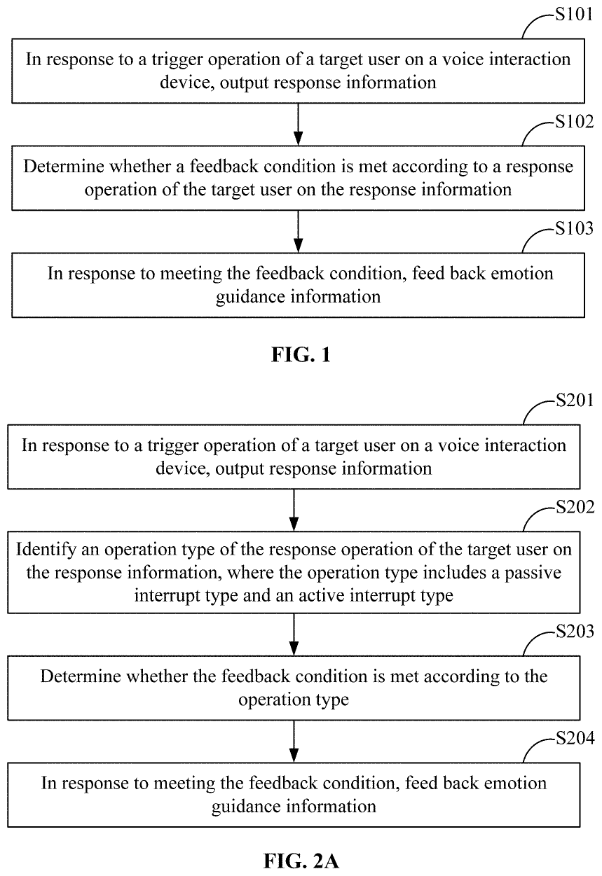

FIG. 1 is a flowchart of a voice interaction method according to an embodiment of the present application. The method includes the steps below.

In S101, in response to a trigger operation of a target user on a voice interaction device, response information is output.

The voice interaction device may be a terminal device having the voice interaction function, such as a smart speaker, a vehicle-mounted terminal or a smartphone. A target user may implement an actual trigger operation or virtual trigger operation on the voice interaction device through the hardware means, man-machine interaction interface or voice receiving port in the voice interaction device.

In an embodiment, the target user may generate the trigger operation by triggering a hardware button, a hardware knob, a set icon or set region of the man-machine interaction interface, and the like. Accordingly, a computing device executing the voice interaction method (hereinafter referred to as a computing device for convenience of description) determines the response information based on a trigger instruction generated from the trigger operation and outputs the response information to the target user through the voice interaction device.

In another embodiment, the target user may input text information, voice information or the like to the voice interaction device in response to the previous response information, that is, the text information input operation or voice information input operation of the target user may be used as a response operation. Accordingly, the computing device determines the response information based on the trigger instruction generated from the trigger operation and outputs the response information to the target user through the voice interaction device.

It is to be noted that the computing device and the voice interaction device in the present application may be the same device or different devices. That is, the computing device may be the voice interaction device itself or may be an operation device, such as an operation server, corresponding to the application installed in the voice interaction device.

In S102, whether a feedback condition is met is determined according to a response operation of the target user on the response information.

In S103, in response to the feedback condition being met, emotion guidance information is fed back.

The response operation of the target user on the response information may be at least one of: recording a voice, sending a recorded voice, deleting a recorded voice, recalling a recorded voice, playing back a recorded voice and playing response information, turning off an application of a voice interaction device, exiting an application of a voice interaction device, or an application of a voice interaction device running in the background.

Exemplarily, whether the feedback condition is met may be set in advance for different response operations so as to determine whether the feedback condition is met in the current voice interaction process in the manner of comparing response operations.

Exemplarily, the various response operations may also be classified in advance and whether the feedback condition is met may be set in advance for different categories so as to determine, in the manner of comparing categories to which the response operations belong, whether the feedback condition is met in the current voice interaction process.

The different response operations of the target user on the response information imply the satisfaction degree of the target user on the application of the voice interaction device or the voice interaction device, and the satisfaction degree is affected by the emotion of the target user to a certain extent.

In order to avoid the situation that the number of stable users of the voice interaction device is reduced since the users have a low interest in the voice interaction device due to the emotion of the target user, the present application distinguishes between meeting the feedback condition and not meeting the feedback condition through the response operation of the target user on the response information. Moreover, when the feedback condition is met, emotion guidance information is fed back to the target user. Thus, whether the feedback condition is met is associated with the emotions of users, and the response operations of target users are distinguished according to emotion types. Then, the response operations related to user emotions and the response operations unrelated to user emotions are determined. Accordingly, the emotion guidance information is fed back in the case where the response operation is related to the emotion of a user, thereby providing some emotional compensation or emotional appeasement to the target user, thus avoiding loss of users of the voice interaction device caused by the emotions of users, and increasing the interest of the users in the voice interaction device and the use stickiness.

Furthermore, if the feedback condition is not met, emotion guidance information is not allowed to be fed back to the user, or non-emotion guidance information may be fed back to the user.

Exemplarily, the emotion guidance information may include at least one of an emotion guidance expression, an emotion guidance statement, and the like, thereby achieving emotion guidance to the target user in different forms and increasing the diversity of voice interaction methods.

In a voice interaction process according to the embodiment of the present application: in response to a trigger operation of a target user on a voice interaction device, response information is output; whether a feedback condition is met is determined according to a response operation of the target user on the response information; and in response to the feedback condition being met, emotion guidance information is fed back. According to the preceding technical scheme, the emotion guidance information is fed back to a target user under necessary circumstances so as to guide or repair the emotion of the target user, avoiding the situation that the target user has a low interest in the voice interaction device or the product stickiness is low due to the emotion of the target user, thus increasing the interest of the user in the voice interaction device and the use stickiness, and thereby laying a foundation for increasing the number of stable users corresponding to the voice interaction device. Meanwhile, the voice recognition in the related art is replaced by the response information in the present application which is used as the basis for determining whether to feed back emotion guidance information, reducing the amount of data computation and increasing the universality of the voice interaction method.

The present application further provides an embodiment on the basis of the preceding various technical schemes. In the embodiment, “determining, according to a response operation of the target user on the response information, whether a feedback condition is met” is refined to “identifying an operation type of the response operation of the target user on the response information, where the operation type includes a passive interrupt type and an active interrupt type; and determining, according to the operation type, whether the feedback condition is met.” so that a voice interaction mechanism is improved.

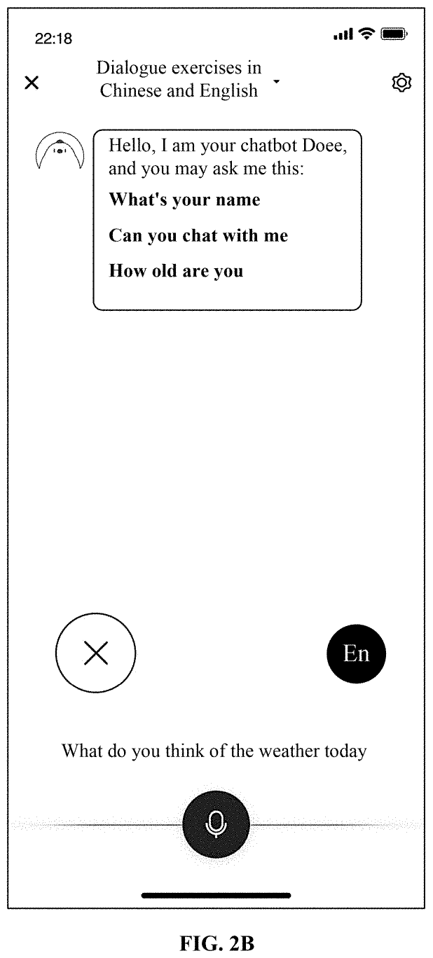

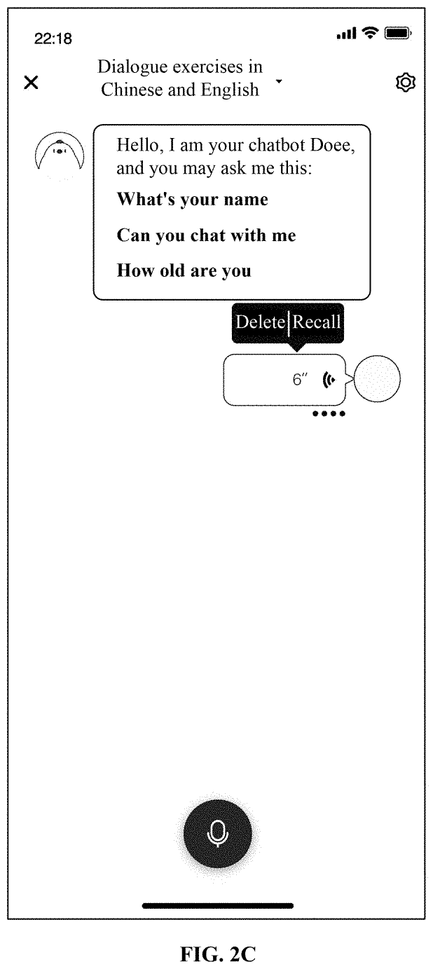

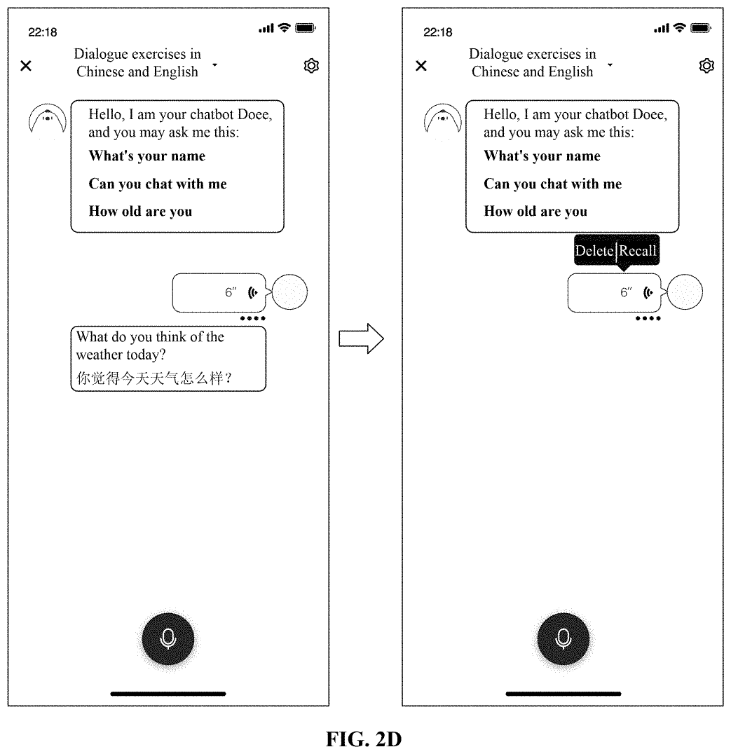

Referring to FIG. 2A, a voice interaction method includes steps described below.

In S201, in response to a trigger operation of a target user on a voice interaction device, response information is output.

In S202, an operation type of the response operation of the target user on the response information is identified, where the operation type includes a passive interrupt type and an active interrupt type.

The passive interrupt type indicates the interrupt use of a voice interaction device by the target user due to the emotion of the target user rather than actual needs. The active interrupt type indicates the interrupt use of a voice interaction device by the target user due to actual needs.

In an embodiment, the operation type of the response operation of the target user on the response information may be determined according to a correspondence between preset different operation types and response operations.

The correspondence between different operation types and response operations may be artificially set, or may be obtained by a statistical analysis of historical response operations of at least one historical user, or may be obtained by a statistical analysis of historical response operations of a target user. The present application does not limit the manner for determining the preceding correspondence.

In an embodiment, when the response operation includes that the number of deletions during voice recording is greater than a first set threshold, the operation type of the response operation is determined to be the passive interrupt type. The first set threshold may be set by a technician according to trial and error or empirical values or may be set or adjusted by a target user according to actual needs. For example, the first set threshold may be 2.

Referring to the schematic diagram of a voice interaction interface shown in FIG. 2B. The voice interaction device displays the following response message to the target user based on a trigger operation of the target user: “Hello, I am your chatbot Doee, and you may ask me this: What's your name, can you chat with me, and how old are you”. Accordingly, if the target user deletes voice information during recording of the voice information, that is, the voice information is deleted after being recorded and before being uploaded, and the number of deletions during recording is 3, the operation type of the response operation is determined to be the passive interrupt type.

It is to be understood that if the response operation includes that the number of deletions after voice recording is greater than the first set threshold, the target user has repeatedly recorded and deleted the voice and does not actually send out voice information, which indicates that the target user determines that the effect of the recorded or deleted voice information is not ideal and the target user expects to record and upload better voice information. Repeated recording and deletion easily lead to low mood or self-confidence decline of the target user, and then the target user has the poor experience in using the voice interaction device. In this case, emotion guidance information is fed back to the target user for emotion guidance or repair of the target user, which can retain the target user to a certain extent and avoid the loss of the target user, thus increasing the use stickiness and the interest of the target user in the voice interaction device.

In another embodiment, the operation type of the response operation is determined to be the passive interrupt type in the case where the response operation includes that the number of recalls after a recorded voice is sent is greater than a second set threshold or that the number of deletions after a recorded voice is sent is greater than a third set threshold. The second set threshold and the third set threshold may be set by a technician according to trial and error or empirical values or may be set or adjusted by a target user according to actual needs respectively. For example, the second set threshold may be 2 and the third set threshold may be 3.

Referring to the schematic diagram of a voice interaction interface shown in FIG. 2C. The voice interaction device displays the following response message to the target user based on a trigger operation of the target user: “Hello, I am your chatbot Doee, and you may ask me this: What's your name, can you chat with me, and how old are you”. Accordingly, if the target user records, sends and recalls a voice and the corresponding number of recalls is counted to be 2, or if the target user records, sends and deletes a voice and the corresponding number of deletions is counted to be 3, the operation type of the response operation is determined to be the passive interrupt type.

It is to be understood that if the response operation includes that the number of recalls after a recorded voice is sent is greater than a second set threshold or that the number of deletions after a recorded voice is sent is greater than a third set threshold, the target user has repeatedly recorded, sent and recalled the voice, which indicates that the target user determines that the sent voice information or the recalled voice information is not ideal and that the target user expects to record and upload better voice information. Repeated recording, uploading and recalls or repeated recording, uploading and deletions easily lead to a low mood or self-confidence decline of the target user, and then the target user has a poor experience in using the voice interaction device. In this case, emotion guidance information is fed back to the target user for emotion guidance or repair of the target user, which can retain the target user to a certain extent and avoid the loss of the target user, thus increasing the use stickiness and the interest of the target user in the voice interaction device.

In another embodiment, the operation type of the response operation is determined to be the passive interrupt type in the case where the response operation includes that the number of times of playback of a sent voice is greater than a fourth set threshold and the sent voice is recalled or that the number of times of playback of a sent voice is greater than a fifth set threshold and the sent voice is deleted. The fourth set threshold and the fifth set threshold may be set by a technician according to trial and error or empirical values or may be set or adjusted by a target user according to actual needs respectively. For example, the fourth set threshold and the fifth set threshold are both 2.

Referring to the schematic diagram of a voice interaction interface shown in FIG. 2D. The voice interaction device displays the following response message to the target user based on a trigger operation of the target user: “Hello, I am your chatbot Doee, and you may ask me this: What's your name, can you chat with me, and how old are you”. Accordingly, if the target user records the voice information of “What do you think of the weather today”, the number of times of playback after the voice information is sent is greater than 2, and the sent voice is recalled or deleted finally, the operation type of the response operation is determined to be the passive interrupt type.

It is to be understood that if the response operation includes that the number of times of playback of a sent voice is greater than a fourth set threshold and the sent voice is recalled or that the number of times of playback of a sent voice is greater than a fifth set threshold and the sent voice is deleted, the target user has repeatedly played and recalled the sent voice, which represents that the target user determines that the sent voice is not ideal. Repeated playback easily leads to a low mood or self-confidence decline of the target user, and then the target user has poor experience in using the voice interaction device. In this case, emotion guidance information is fed back to the target user for emotion guidance or repair of the target user, which can retain the target user to a certain extent and avoid the loss of the target user, thus increasing the use stickiness and the interest of the target user in the voice interaction device.

It is to be noted that the first set threshold, the second set threshold, the third set threshold, the fourth set threshold and the fifth set threshold may be the same or at least partially different, which is not limited herein.

The manner of determining the response operation of the passive interrupt type has been exemplarily described, and the manner of determining a response operation of the active interrupt type is described below.

In an embodiment, the operation type is determined to be the active interrupt type in a case where the response operation includes at least one of the following: not responding to the response information within first set duration, receiving no recorded information within second set duration after the response information is played, exiting an application of a voice interaction device, or an application of a voice interaction device running in the background. The first set duration and the second set duration may be set by a technician according to trial and error or empirical values or may be set or adjusted by a target user according to actual needs. It is to be noted that the first set duration and the second set duration may be the same or different, which is not limited in the present application.

It is to be understood that if the target user does not respond to the response information within the first set duration, the target user does not perform any operation related to voice recording. The target user does not record, upload, delete, recall or play a voice, which represents that the target user actively interrupts a voice interaction process instead of passively interrupting the voice interaction process due to the influence of the emotion of the target user. If no recorded information is received within the second set duration after the response information is played, the current response information has met the use requirement of the target user, which represents that the target user actively interrupts the voice interaction instead of passively interrupting the voice interaction process due to the influence of the emotion of the target user. If the response message is received and it is detected that the black version of the application of voice interaction is exited or runs in the background, the current response information has met the use requirement of the target user, which represents that the target user actively interrupts the voice interaction instead of passively interrupting the voice interaction process due to the influence of the emotion of the target user. Therefore, in at least one of the preceding cases, emotion guidance information does not need to be fed back to the target user, avoiding resentment from the user caused by excessive disturbance to the target user.

In an embodiment, the operation type may also include a continuous interaction type. Accordingly, the step of identifying an operation type of the response operation of the target user on the response information may be as follows: the target user may perform voice interaction with the voice interaction device and the operation type may be determined to be the continuous interaction type in a case where the response operation includes at least one of the following: a set application for voice interaction runs in the foreground, the number of deletions during voice recording is not greater than the first set threshold, the number of recalls after a recorded voice is sent is not greater than the second set threshold, the number of deletions after a recorded voice is sent is not greater than the third set threshold, the number of times of playback of a sent voice is not greater than the fourth set threshold, the sent voice is not deleted, or the sent voice is not recalled.

In S203, whether the feedback condition is met is determined according to the operation type.

In S204, in response to the feedback condition being met, emotion guidance information is fed back.

Exemplarily, if the operation type is the passive interrupt type, it is determined that the feedback condition is met, and the emotion guidance information is fed back, thereby providing compensation or appeasement for the negative emotions of the target user, thus avoiding loss of the user of the voice interaction device caused by the emotion of the user, and increasing the use stickiness and the interest of the user in the voice interaction device.

Exemplarily, if the operation type is the active interrupt type, it is determined that the feedback condition is not met, and the emotion guidance information is not allowed to be fed back, thereby avoiding resentment from the user caused by excessive disturbance to the target user in the case where the target user actively interrupts the voice interaction.

Exemplarily, if the operation type is the continuous interaction type, it is determined that the feedback condition is not met, and the emotion guidance information is not allowed to be fed back, thereby avoiding resentment from the user caused by excessive disturbance to the target user in the case where the target user performs the voice interaction with the voice interaction device.

According to the embodiment of the present application, the operation of determining whether to feed back the emotion guidance information is refined to: identifying the operation type of the response operation of the target user on the response information, where the operation type includes the passive interrupt type and the active interrupt type; and determining whether the feedback condition is met according to the operation type. According to the preceding technical scheme, the operation type of the response operation is introduced as the basis for determining whether to feedback emotion guidance information, and the determination mechanism of whether to feed back the emotion guidance information is further improved, laying the foundation for increasing the use stickiness and the interest of the target user in the voice interaction device.

On the basis of the preceding various technical schemes, the emotion guidance information is refined to include an emotion guidance expression and/or an emotion guidance statement. The use or generation mechanism of the emotion guidance expression or emotion guidance statement is described in detail below.

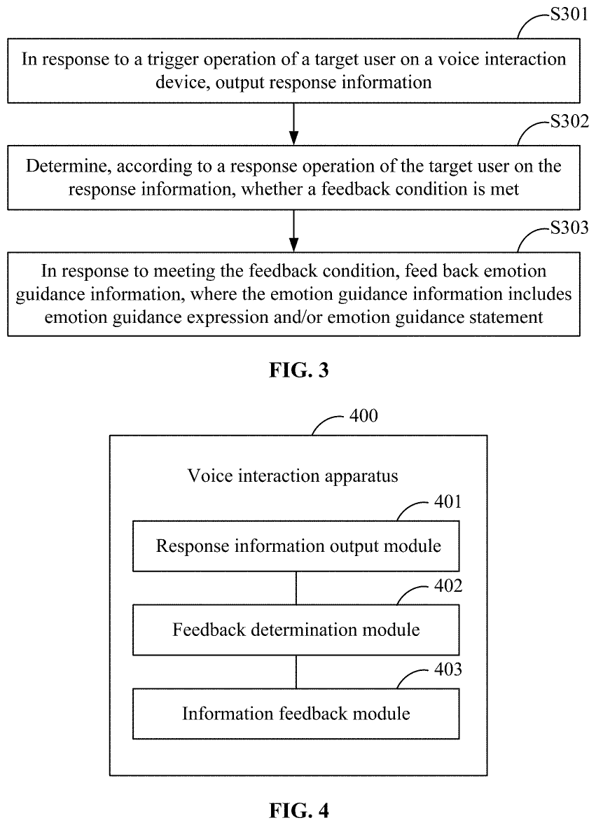

Referring to FIG. 3, a voice interaction method includes steps described below.

In S301, in response to a trigger operation of a target user on a voice interaction device, response information is output.

In S302, whether a feedback condition is met is determined according to a response operation of the target user on the response information.

In S303, in response to the feedback condition being met, emotion guidance information is fed back. The emotion guidance information includes the emotion guidance expression and/or the emotion guidance statement.

In an embodiment, the emotion guidance information may include the emotion guidance expression. Exemplarily, the emotion guidance expression may include at least one of an expression picture, a character expression, or the like. For example, the expression picture may be a preset meme, a custom animation, or the like; and the character expression may be kaomoji, an emoji, or the like.

Exemplarily, an expression list may be preset for storing at least one emotion guidance expression, and when emotion guidance information needs to be fed back, at least one emotion guidance expression is selected from the emotion list according to a first set selection rule and fed back to the target user through the voice interaction device. The first set selection rule may be random selection, alternate selection, selection according to time periods, or the like.

However, when the target user turns on the voice interaction device, if the target user has not yet performed voice interaction with the voice interaction device, rashly feeding back a general emotion guidance expression to the target user may cause resentment from the target user or produce ambiguity. To avoid the preceding case, in an embodiment, the emotion guidance expression may be divided into an encouraging emoticon and a non-encouraging emoticon. Accordingly, in the case where the response information is an output result of the first trigger operation, the emotion guidance expression to be fed back is a non-encouraging emoticon such as a lovely expression; in the case where the response information is an output result of a non-first trigger operation, the emotion guidance expression is an encouraging emoticon such as a cheer expression.

In an embodiment, a list of encouraging expressions and a list of non-encouraging expressions may be set. Accordingly, when an encouraging emoticon needs to be fed back, at least one emotion guidance expression is selected from the list of encouraging expressions according to a second set selection rule and fed back to the target user through the voice interaction device. The second set selection rule may be random selection, alternate selection, selection according to time periods, or the like. When a non-encouraging emoticon needs to be fed back, at least one emotion guidance expression is selected from the list of non-encouraging expressions according to a third set selection rule and fed back to the target user through the voice interaction device. The third set selection rule may be random selection, alternate selection, selection according to time periods, or the like. The first set selection rule, the second set selection rule and the third set selection rule may be different or at least partially the same, which is not limited herein.

To avoid expression ambiguity, to avoid that the target user considers the expression is perfunctory and to enrich the diversity of voice interaction methods, in another embodiment, the emotion guidance information may include the emotion guidance statement. Exemplarily, the emotion guidance statement may be a basic evaluation statement and/or an additional evaluation statement generated according to historical voice information fed back based on at least one piece of historical response information, so that the voice interaction manner is enriched and the diversity of voice interaction is increased.

Exemplarily, the basic evaluation statement may be understood as an evaluation word or evaluation sentence having an emotion guidance meaning and obtained through evaluation of historical voice information from the overall level. The basic evaluation statement is, for example, a set evaluation statement such as “great”, “beautiful” and “quite well”.

In an embodiment, a basic evaluation statement library may be constructed in advance for storing at least one basic evaluation statement; accordingly, the basic evaluation statement is selected from the basic evaluation statement library through a fourth set selection rule and fed back to the target user through the voice interaction device. The fourth set selection rule may be random selection, alternate selection, selection according to time periods, or the like.

It is to be understood that after the basic evaluation statement library is constructed, the basic evaluation statement library may be updated in real time or on a regular basis as required.

Exemplarily, the additional evaluation statement may be understood as an evaluation statement having an emotion guidance meaning and obtained through evaluation of historical voice information in at least one dimension from the detail level. The evaluation dimension may be an evaluation object dimension such as sentence, vocabulary and grammar for providing a positive evaluation. The evaluation dimension may also include at least one evaluation index dimension such as accuracy, complexity and fluency for providing a positive evaluation for at least one evaluation object.

For an additional evaluation statement, the additional evaluation statement may be selected from the pre-constructed additional evaluation statement library according to a certain selection rule. The voice interaction behavior of the target user is qualitatively evaluated in at least one evaluation index dimension corresponding to the additional evaluation statement.

To improve the fit degree between the additional evaluation statement and the voice interaction behavior of the target user, in an embodiment, the additional evaluation statement may also be determined in the following manner: analyzing the historical voice information fed back by the target user based on at least one piece of historical response information so as to generate at least one candidate evaluation index; and a target evaluation index is selected from the at least one candidate evaluation index, and the additional evaluation statement is generated based on a set statement template.

It is to be understood that the candidate evaluation index is generated with the aid of the historical voice information fed back by the user based on the historical response information so that the generated candidate evaluation index better fits the voice interaction behavior of the target user, thus improving the flexibility of the voice interaction process and laying a foundation for successful emotion guidance.

In an embodiment, the historical response information may be at least one piece of most recently generated response information; accordingly, the historical voice information is at least one piece of voice information most recently generated by the target user. Typically, the historical voice information is the latest voice information.

In an embodiment, the candidate evaluation index may include at least one of the following: vocabulary accuracy, vocabulary complexity, grammar accuracy, grammar complexity, or statement fluency. The vocabulary accuracy is used for characterizing the accuracy of vocabulary pronunciation, vocabulary usage, vocabulary collocation and the like in historical voice information. The vocabulary complexity is used for characterizing the use frequency of advanced vocabularies or difficult vocabularies in historical voice information. The grammar accuracy is used for characterizing the accuracy of grammatical structures used in historical voice information. The grammar complexity is used for characterizing the frequency of advanced grammar to which the grammatical structure adopted in historical voice information belongs. The statement fluency is used for characterizing the fluency of historical voice information recorded by the user.

It is to be understood that through the enumeration of different candidate evaluation indexes described above, the expressive forms of the additional evaluation statement are enriched, and then the diversity of emotion guidance information is increased.

In an embodiment, the vocabulary accuracy is determined according to vocabulary collocation and/or vocabulary pronunciation of a vocabulary included in the historical voice information. Exemplarily, historical voice information may be split into at least one target vocabulary according to vocabulary collocation; the accuracy of the target vocabulary is determined according to the accuracy of the vocabulary pronunciation and/or the vocabulary collocation of each target vocabulary and used as the vocabulary accuracy of the historical voice information.

The evaluation criterion of vocabulary pronunciation may be preset. For example, in spoken English, British pronunciation or American pronunciation is used as the evaluation criterion.

In an embodiment, the vocabulary complexity is determined according to a historical use frequency of a set vocabulary included in the historical voice information. Exemplarily, historical voice information may be split into at least one target vocabulary according to vocabulary collocation; the historical usage frequency of an advanced vocabulary or difficult vocabulary among the at least one target vocabulary in a set historical period is used as the vocabulary complexity. The advanced vocabulary may be a network vocabulary, slang, uncommon vocabulary, etc.

In an embodiment, the grammar accuracy is determined according to the result of a comparison between a grammatical structure of the historical voice information and a standard grammatical structure. Exemplarily, the historical voice information may be analyzed to obtain the grammatical structure of the historical voice information; the standard grammatical structure corresponding to the historical voice information is obtained, and the grammatical structure of the historical voice information is compared with the standard grammatical structure; and the grammatical accuracy is generated according to the consistency of the comparison result.

In an embodiment, when grammatical structure comparison is performed, at least one of statement tenses, statement components, third person singular or singular and plural variations of vocabularies may be compared.

In an embodiment, it may be determined whether the grammatical structure of historical voice information is a set grammatical structure (for example, an advanced grammatical structure such as a multi-layer nesting structure or an uncommon grammatical structure); if yes, the historical use frequency of the set grammatical structure in a set historical period is used as the vocabulary complexity.

In an embodiment, the statement fluency is determined according to at least one of the number of vocabulary repetitions, a pause vocabulary occurrence frequency, or pause duration in the historical voice information. Exemplarily, pause duration intervals corresponding to different statement fluency are divided in advance, and the duration between at least two pause vocabularies is used as the pause duration; the statement fluency is determined according to the duration interval to which the pause duration belongs and in historical voice information. Alternatively, the statement fluency is determined according to the frequency of occurrence of a pause vocabulary. Alternatively, the statement fluency is determined according to the number of consecutive occurrences of the same vocabulary in a historical statement. The pause vocabulary may be preset or adjusted by a technician or a target user according to needs or empirical values and for example, is “hmm”, “this”, “that” and the like.

It is to be understood that to achieve the emotion guidance effect, when a target evaluation index is selected from at least one candidate evaluation index, a candidate evaluation index with a higher (for example, the highest) value among the at least one candidate evaluation index is selected as the target evaluation index.

In an embodiment, the set statement template may be a primary statement template formed by “your”+“template evaluation index”+“adjective”. To further improve emotional fullness, a degree word (such as “more and more” and “more than usual”) may be added between the template evaluation index and the adjective in the primary statement template, and/or an interjection (such as “oh”, “yo” and “yeah”) may be added after the adjective so as to generate an advanced statement template.

It is to be noted that the target evaluation index may merely include an index object, and of course, may also include a specific index value.

For example, when the target evaluation index is the grammar accuracy, the generated additional evaluation statement may be “Oh, your grammar accuracy is getting better and better” or “Oh, your grammar accuracy is improved by 10%”.

According to the embodiments of the present application, the emotion guidance information is refined to include an emotion guidance expression and/or an emotion guidance statement, enriching the expressive forms of the emotion guidance information, and thus increasing the diversity of voice interaction methods.

In implementation of the various voice interaction methods, the present application further provides an embodiment in which a virtual apparatus for implementing the various voice interaction methods is provided. Referring to FIG. 4, a voice interaction apparatus 400 includes a response information output module 401, a feedback determination module 402 and an information feedback module 403.

The response information output module 401 is configured to: in response to a trigger operation of a target user on a voice interaction device, output response information.

The feedback determination module 402 is configured to determine, according to a response operation of the target user on the response information, whether a feedback condition is met.

The information feedback module 403 is configured to: in response to the feedback condition being met, feed back emotion guidance information.

In a voice interaction process in the embodiment of the present application: in response to a trigger operation of a target user on a voice interaction device, response information is output by the response information output module; whether a feedback condition is met is determined by the feedback determination module according to a response operation of the target user on the response information; and in response to the feedback condition being met, emotion guidance information is fed back. According to the preceding technical scheme, emotion guidance information is fed back to a target user under necessary circumstances so as to guide or repair the emotion of the target user, avoiding the situation that the target user has low interest in the voice interaction device or the product stickiness is low due to the emotion of the target user, thus increasing the interest of the user in the voice interaction device and the use stickiness, and thereby laying a foundation for increasing the number of stable users corresponding to the voice interaction device. Meanwhile, the voice recognition in the related art is replaced by the response information in the present application which is used as the basis for determining whether to feed back emotion guidance information, reducing the amount of data computation and increasing the universality of the voice interaction method.

In an embodiment, the feedback determination module 402 includes an operation type identification unit and a feedback determination unit.

The operation type identification unit is configured to identify an operation type of the response operation of the target user on the response information. The operation type includes a passive interrupt type and an active interrupt type.

The feedback determination unit is configured to determine, according to the operation type, whether the feedback condition is met.

In an embodiment, the feedback determination unit includes a feedback determination sub-unit and a feedback prohibition sub-unit.

The feedback determination sub-unit is configured to: in a case where the operation type is the passive interrupt type, determine that the feedback condition is met.

The feedback prohibition sub-unit is configured to: in a case where the operation type is the active interrupt type, determine that the feedback condition is not met.

In an embodiment, the operation type identification unit includes a passive interrupt type determination sub-unit and an active interrupt type determination sub-unit.

The passive interrupt type determination sub-unit is configured to determine that the operation type is the passive interrupt type in a case where the response operation includes at least one of the following: the number of deletions during voice recording is greater than a first set threshold, the number of recalls after a recorded voice is sent is greater than a second set threshold, the number of deletions after a recorded voice is sent is greater than a third set threshold, the number of times of playback of a sent voice is greater than a fourth set threshold and the sent voice is recalled, or the number of times of playback of a sent voice is greater than a fifth set threshold and the sent voice is deleted.

The active interrupt type determination sub-unit is configured to determine that the operation type is the active interrupt type in a case where the response operation includes at least one of the following: not responding to the response information within first set duration, receiving no recorded information within second set duration after the response information is played, exiting an application of a voice interaction device, or an application of a voice interaction device running in a background.

In an embodiment, the emotion guidance information includes an emotion guidance expression and/or an emotion guidance statement.

In an embodiment, the emotion guidance statement includes a basic evaluation statement and/or an additional evaluation statement.

In an embodiment, the apparatus further includes an additional evaluation statement determination module configured to determine the additional evaluation statement.

The additional evaluation statement determination module includes a candidate evaluation index generation unit and an additional evaluation statement generation unit.

The candidate evaluation index generation unit is configured to analyze historical voice information fed back by the target user based on at least one piece of historical response information so as to generate at least one candidate evaluation index.

The additional evaluation statement generation unit is configured to: select a target evaluation index from the at least one candidate evaluation index, and generate the additional evaluation statement based on a set statement template.

In an embodiment, the candidate evaluation index includes at least one of vocabulary accuracy, vocabulary complexity, grammar accuracy, grammar complexity, or statement fluency.

In an embodiment, the candidate evaluation index generation unit includes a vocabulary accuracy determination sub-unit and a vocabulary complexity determination sub-unit.

The vocabulary accuracy determination sub-unit is configured to determine the vocabulary accuracy according to vocabulary collocation and/or vocabulary pronunciation of a vocabulary included in the historical voice information.

The vocabulary complexity determination sub-unit is configured to determine the vocabulary complexity according to a historical use frequency of a set vocabulary included in the historical voice information.

The grammar accuracy determination sub-unit is configured to determine the grammar accuracy according to a result of a comparison between a grammatical structure of the historical voice information and a standard grammatical structure.

The grammar complexity determination sub-unit is configured to: in a case where the grammatical structure of the historical voice information is a set grammatical structure, determine the grammar complexity according to a historical use frequency of the set grammatical structure.

The statement fluency determination sub-unit is configured to determine the statement fluency according to at least one of the number of vocabulary repetitions, a pause-vocabulary occurrence frequency, or pause duration in the historical voice information.

In an embodiment, if the response information is an output result of a first trigger operation, the emotion guidance expression is a non-encouraging emoticon; and if the response information is an output result of a non-first trigger operation, the emotion guidance expression is an encouraging emoticon.

The preceding voice interaction apparatus may execute the voice interaction method provided by any embodiment of the present application and has functional modules and beneficial effects corresponding to the executed voice interaction method.

According to the embodiments of the present application, the present application further provides an electronic device, a readable storage medium and a computer program product.

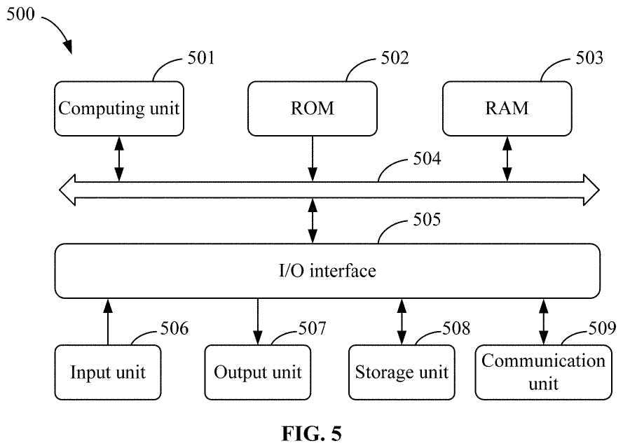

FIG. 5 shows a block diagram illustrative of an exemplary electronic device 500 that may be used for implementing the embodiments of the present application. Electronic devices are intended to represent various forms of digital computers, for example, laptop computers, desktop computers, worktables, personal digital assistants, servers, blade servers, mainframe computers and other applicable computers. Electronic devices may also represent various forms of mobile devices, for example, personal digital assistants, cellphones, smartphones, wearable devices and other similar computing devices. Herein the shown components, the connections and relationships between these components, and the functions of these components are illustrative only and are not intended to limit the implementation of the present application as described or claimed herein.

As shown in FIG. 5, the device 500 includes a computing unit 501. The computing unit 501 may perform various appropriate actions and processing according to a computer program stored in a read-only memory (ROM) 502 or a computer program loaded into a random-access memory (RAM) 503 from a storage unit 508. The RAM 503 may also store various programs and data required for operations of the device 500. The computing unit 501, the ROM 502 and the RAM 503 are connected to each other by a bus 504. An input/output (I/O) interface 505 is also connected to the bus 504.

Multiple components in the device 500 are connected to the I/O interface 505. The multiple components include an input unit 506 such as a keyboard or a mouse, an output unit 507 such as various types of displays or speakers, the storage unit 508 such as a magnetic disk or an optical disk, and a communication unit 509 such as a network card, a modem or a wireless communication transceiver. The communication unit 509 allows the device 500 to exchange information/data with other devices over a computer network such as the Internet and/or over various telecommunication networks.

The computing unit 501 may be a general-purpose and/or special-purpose processing component having processing and computing capabilities. Examples of the computing unit 501 include, but are not limited to, a central processing unit (CPU), a graphics processing unit (GPU), a special-purpose artificial intelligence (AI) computing chip, a computing unit executing machine learning model algorithms, a digital signal processor (DSP) and any appropriate processor, controller and microcontroller. The computing unit 501 executes various methods and processing described above, such as the video interaction method. For example, in some embodiments, the video interaction method may be implemented as computer software programs tangibly contained in a machine-readable medium such as the storage unit 508. In some embodiments, part or all of computer programs may be loaded and/or installed on the device 500 via the ROM 502 and/or the communication unit 509. When the computer program is loaded to the RAM 503 and executed by the computing unit 501, one or more steps of the preceding voice interaction method may be executed. Alternatively, in other embodiments, the computing unit 501 may be configured, in any other suitable manner (for example, by means of firmware), to execute the video interaction method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), and computer hardware, firmware, software and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input device and at least one output device and transmitting data and instructions to the memory system, the at least one input device and the at least one output device.

Program codes for implementation of the method of the present application may be written in any combination of one or more programming languages. These program codes may be provided for the processor or controller of a general-purpose computer, a special-purpose computer or another programmable data processing device to enable functions/operations specified in a flowchart and/or a block diagram to be implemented when the program codes are executed by the processor or controller. The program codes may be executed entirely on a machine, partly on the machine, as a stand-alone software package, partly on the machine and partly on a remote machine, or entirely on the remote machine or server.

In the context of the present application, the machine-readable medium may be a tangible medium that may contain or store a program available for an instruction execution system, apparatus or device or a program used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any appropriate combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on a computer. The computer has a display device (for example, a cathode-ray tube (CRT) or liquid-crystal display (LCD) monitor) for displaying information to the user; and a keyboard and a pointing device (for example, a mouse or a trackball) through which the user can provide input for the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. The components of the system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the clients and the servers arises by virtue of computer programs running on the respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS) service. The server may also be a server of a distributed system, or a server combined with blockchain.

Artificial intelligence is the study of making computers simulate certain human thinking processes and intelligent behaviors (such as learning, reasoning, thinking and planning) both at the hardware and software levels. Artificial intelligence hardware technologies generally include technologies such as sensors, dedicated artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

The present application further provides a voice interaction device configured with the computer program product according to any embodiment. Exemplarily, the voice interaction device may be a smart speaker, a vehicle-mounted terminal, a smartphone or the like.

It is to be understood that various forms of the preceding flows may be used, with steps reordered, added or removed. For example, the steps described in the present application may be executed in parallel, in sequence or in a different order as long as the desired result of the technical scheme disclosed in the present application is achieved. The execution sequence of these steps is not limited herein.

The scope of the present application is not limited to the preceding embodiments. It is to be understood by those skilled in the art that various modifications, combinations, sub-combinations and substitutions may be made depending on design requirements and other factors. Any modifications, equivalent substitutions, improvements and the like made within the spirit and principle of the present application are within the scope of the present application.

What is claimed is:

1. A voice interaction method, comprising:
in response to a trigger operation of a target user on a voice interaction device, outputting response information;
determining, according to a response operation of the target user on the response information, whether a feedback condition is met; and
in response to meeting the feedback condition, feeding back emotion guidance information.

2. The method of claim 1, wherein determining, according to the response operation of the target user on the response information, whether the feedback condition is met comprises:
identifying an operation type of the response operation of the target user on the response information; wherein the operation type comprises a passive interrupt type and an active interrupt type; and
determining, according to the operation type, whether the feedback condition is met.

3. The method of claim 2, wherein determining, according to the operation type, whether the feedback condition is met comprises:
in a case where the operation type is the passive interrupt type, determining that the feedback condition is met; or
in a case where the operation type is the active interrupt type, determining that the feedback condition is not met.

4. The method of claim 2, wherein identifying the operation type of the response operation of the target user on the response information comprises:
determining that the operation type is the passive interrupt type in a case where the response operation comprises at least one of the following: a number of deletions during voice recording being greater than a first set threshold, a number of recalls after a recorded voice is sent being greater than a second set threshold, a number of deletions after a recorded voice is sent being greater than a third set threshold, a number of times of playback of a sent voice being greater than a fourth set threshold and the sent voice being recalled, or a number of times of playback of a sent voice being greater than a fifth set threshold and the sent voice being deleted; and
determining that the operation type is the active interrupt type in a case where the response operation comprises at least one of the following: not responding to the response information within first set duration, receiving no recorded information within second set duration after the response information is played, exiting an application of a voice interaction device, or an application of a voice interaction device running in a background.

5. The method of claim 1, wherein the emotion guidance information comprises at least one of an emotion guidance expression or an emotion guidance statement.

6. The method of claim 2, wherein the emotion guidance information comprises at least one of an emotion guidance expression or an emotion guidance statement.

7. The method of claim 3, wherein the emotion guidance information comprises at least one of an emotion guidance expression or an emotion guidance statement.

8. The method of claim 5, wherein the emotion guidance statement comprises at least one of a basic evaluation statement or an additional evaluation statement.

9. The method of claim 8, wherein the additional evaluation statement is determined in the following manner:
analyzing historical voice information fed back by the target user based on at least one piece of historical response information to generate at least one candidate evaluation index; and
selecting a target evaluation index from the at least one candidate evaluation index, and generating the additional evaluation statement based on a set statement template.

10. The method of claim 9, wherein the at least one candidate evaluation index comprises at least one of: vocabulary accuracy, vocabulary complexity, grammar accuracy, grammar complexity, or statement fluency.

11. The method of claim 10, wherein analyzing the historical voice information fed back by the target user based on the at least one piece of historical response information to generate the at least one candidate evaluation index comprises:
determining the vocabulary accuracy according to at least one of vocabulary collocation or vocabulary pronunciation of a vocabulary included in the historical voice information;
determining the vocabulary complexity according to a historical use frequency of a set vocabulary included in the historical voice information;
determining the grammar accuracy according to a result of a comparison between a grammatical structure of the historical voice information and a standard grammatical structure;
in a case where the grammatical structure of the historical voice information is a set grammatical structure, determining the grammar complexity according to a historical use frequency of the set grammatical structure; and
determining the statement fluency according to at least one of a number of vocabulary repetitions, a pause-vocabulary occurrence frequency, or pause duration in the historical voice information.

12. The method of claim 5, wherein in response to the response information being an output result of a first trigger operation, the emotion guidance expression is a non-encouraging emoticon; and in response to the response information being an output result of a non-first trigger operation, the emotion guidance expression is an encouraging emoticon.

13. An electronic device, comprising:
at least one processor; and
a memory communicatively connected to the at least one processor;
wherein the memory stores instructions executable by the at least one processor, and the instructions are executed by the at least one processor to cause the at least one processor to perform the following steps:
in response to a trigger operation of a target user on a voice interaction device, outputting response information;
determining, according to a response operation of the target user on the response information, whether a feedback condition is met; and
in response to meeting the feedback condition, feeding back emotion guidance information.

14. The electronic device of claim 13, wherein the at least one processor performs determining, according to the response operation of the target user on the response information, whether the feedback condition is met by:
identifying an operation type of the response operation of the target user on the response information; wherein the operation type comprises a passive interrupt type and an active interrupt type; and
determining, according to the operation type, whether the feedback condition is met.

15. The electronic device of claim 14, wherein the at least one processor performs determining, according to the operation type, whether the feedback condition is met by:
in a case where the operation type is the passive interrupt type, determining that the feedback condition is met; or
in a case where the operation type is the active interrupt type, determining that the feedback condition is not met.

16. The electronic device of claim 14, wherein the at least one processor performs identifying the operation type of the response operation of the target user on the response information by:
determining that the operation type is the passive interrupt type in a case where the response operation comprises at least one of the following: a number of deletions during voice recording being greater than a first set threshold, a number of recalls after a recorded voice is sent being greater than a second set threshold, a number of deletions after a recorded voice is sent being greater than a third set threshold, a number of times of playback of a sent voice being greater than a fourth set threshold and the sent voice being recalled, or a number of times of playback of a sent voice being greater than a fifth set threshold and the sent voice being deleted; and
determining that the operation type is the active interrupt type in a case where the response operation comprises at least one of the following: not responding to the response information within first set duration, receiving no recorded information within second set duration after the response information is played, exiting an application of a voice interaction device, or an application of a voice interaction device running in a background.

17. The electronic device of claim 13, wherein the emotion guidance information comprises at least one of an emotion guidance expression or an emotion guidance statement.

18. The electronic device of claim 17, wherein the emotion guidance statement comprises at least one of a basic evaluation statement or an additional evaluation statement.

19. The electronic device of claim 18, wherein the additional evaluation statement is determined in the following manner:
analyzing historical voice information fed back by the target user based on at least one piece of historical response information to generate at least one candidate evaluation index; and
selecting a target evaluation index from the at least one candidate evaluation index, and generating the additional evaluation statement based on a set statement template.

20. A non-transitory computer-readable storage medium storing a computer instruction, wherein the computer instruction is configured to cause a computer to perform the following steps:
in response to a trigger operation of a target user on a voice interaction device, outputting response information;
determining, according to a response operation of the target user on the response information, whether a feedback condition is met; and
in response to meeting the feedback condition, feeding back emotion guidance information.
